(19) United States
(12) Patent Application Publication
(10) Pub. No.: US 2005/0079738 A1
(43) Pub. Date: Apr. 14, 2005

(54) USB storage device including USB plug with top and bottom terminals

(75) Inventor: Hyoung-Jun Ahn, Paldal-gu (KR)

Correspondence Address: STAAS & HALSEY LLP, SUITE 700, 1201 NEW YORK AVENUE, N.W., WASHINGTON, DC, 20005, US

(73) Assignee: STS SEMICONDUCTOR AND TELECOMMUNICATIONS CO., LTD., Chungcheongnam-do (KR)

(21) Appl. No.: 10/923,082

(22) Filed: Aug. 23, 2004

(30) Foreign Application Priority Data
Sep. 1, 2003 (KR) 2003-60691

(51) Int. Cl. H01R 39/00

(52) U.S. Cl. 439/1

(57) ABSTRACT

The present invention relates to a USB storage device having a USB plug with top and bottom terminals, connection terminals of the USB plug being provided at both top and bottom sides so that an information terminal apparatus such as a PC, a notebook, an MP3 player and a digital camera, can be inserted in face-down/face-up manners, comprising a main unit and a cover unit, the main unit comprising a USB plug having connection terminals at both sides to be connected to a USB port of the information terminal apparatus to communicate data, and slide rails provided in a longitudinal direction to define a sliding range for rail protrusions of the cover unit; and the cover unit comprising rail protrusions inserted into the slide rails and provided at both ends of the cover unit toward the main unit so that the cover unit can rotatably move along with the slide rail. Therefore, since the USB storage device according to the present invention includes the connection terminals of the USB plug at top and bottom sides, it can be inserted into the information terminal apparatus in a face-down or face-up manner. Further, in the USB storage device according to the present invention, the sliding range for the rail protrusions provided on the cover unit is defined into the slide rails extending the corresponding main unit, thereby preventing the cover unit from being separated and missing.

### BACKGROUND OF THE INVENTION

1. Field of the Invention

The present invention relates to a universal serial bus (USB) storage device having a USB plug with top and bottom terminals, and more particularly, to a USB storage device having a USB plug with top and bottom terminals, connection terminals of the USB plug being provided at top and bottom sides to be inserted into an information terminal apparatus such as a PC, a notebook, an MP3 player and a digital camera, in face-down/face-up manners.

2. Description of Related Art

With the development of information and communication technology, an information terminal apparatus such as a PC, a notebook, an MP3 player and a digital camera, has been widely used. However, the information terminal apparatus is subject to loss of critical data due to errors in a variety of hardware or software, so that data backup should be performed using a data storage device such as a hard disk, a magnetic tape and an optical disk.

As the storage device, the optical disk such as a CD-ROM is most widely used. This is because the optical disk can store relatively large amount of data with a low cost, even though it has a low access rate compared with the hard disk. However, once data is recorded on the CD-ROM, it is difficult to erase and record data again. Moreover, since the CD-ROM has a large size, it is inconvenient to carry with CD-ROM. Since its recorded data is vulnerable to dirt or electromagnetic field, it is difficult to stably maintain data.

Therefore, a USB storage device using a USB port has been widely used among portable storage devices to overcome a drawback of the optical disk such as a CD-ROM. The USB storage device uses a flash memory, and is connected to the USB port of the information terminal apparatus to read or write data, which acts as a plug-and-play device in the information terminal apparatus.

For a memory device of this USB storage device, there can be used an IEEE 1394 device, a memory stick (MS), a compact flash card (CFC), a multi-media card (MMC) and a smart media card (SMC) and the like, based on connection schemes. A capacity of the flash memory for use in the USB storage device can be ranged from 4 MB, 8 MB, 16 MB, 32 MB, 64 MB, and 128 MB to more than 2 GB.

However, in the conventional USB storage device, the USB plug is inserted into the USB port only in a face-up or face-down manner. Therefore, when the USB plug is used upside-down, a light emitting diode (LED) for checking data communication is not seen so that a user cannot determine whether the USB storage device is in use or not, which may cause the user to inadvertently separate the USB storage device from the information terminal apparatus while data is communicated. Unfortunately, when the USB storage device is separated, the USB storage device as well as data cannot be used any longer.

Further, since the conventional USB storage device has a separated cover unit, when the USB storage device is inserted into the USB port of the information terminal apparatus, the cover unit should be separated from the USB storage device. In this process, the cover unit may be missing.

Moreover, the conventional USB storage device is large and bulky so that when inserted into the USB port of the information terminal apparatus, other peripheral devices may not be inserted, or other functional ports may be blocked or partially hidden, leading to other peripheral devices hard to use at the same time.

### SUMMARY OF THE INVENTION

To solve the foregoing problems, the present invention provides a USB storage device that can be inserted into an information terminal apparatus such as a PC, a notebook, an MP3 player, and a digital camera, in face-down/face-up manners.

The present invention also provides a USB storage device to prevent a cover unit of the USB storage device from being separated and missing.

The present invention also provides a USB storage device that is thin enough not to block other functional ports.

According to an aspect of the present invention, there is provided a USB storage device having a bidirectional terminal USB plug comprising: a main unit for receiving a memory device storing data; and a cover unit protecting the main unit from external environment, wherein the main unit comprises: a USB plug having a connection terminal at one side thereof to be connected to a USB port of an information terminal apparatus to communicate data and another connection terminal at the other side thereof to be connected to the USB port of the information terminal apparatus to communicate data at the other side; and slide rails provided in a longitudinal direction along both sides to define a sliding range for rail protrusions of the cover unit, and wherein the cover unit comprises rail protrusions provided at both ends toward the main unit thereof to be inserted into the slide rails, so that the cover unit can rotatably move along with the slide rail.

In the USB storage device according to the present invention, the slide rails may extend in the longitudinal direction within the cover unit, and the rail protrusions corresponding to the slide rails may be provided at both sides of the main unit.

In the USB storage device according to the present invention, the connection terminal at one side and the connection terminal at the other side of the USB plug may be symmetrically coupled with reference to a center of the USB plug.

In the USB storage device according to the present invention, the USB plug may further comprise a guide made of dielectric material between the connection terminals to prevent a short circuit between the connection terminals.

In the USB storage device according to the present invention, a thickness of the main unit may be in a range of 2 mm to 3 mm so that the main unit can be inserted into a small-sized information terminal apparatus.

In the USB storage device according to the present invention, slide rail projections may be provided at both ends of the slide rails to prevent the rail protrusions from being separated from the slide rails.

In the USB storage device according to the present invention, the main unit may further comprise: upper cover fixing grooves concavely provided toward the USB plug at both ends of the slide rail in the main unit so that inserting protrusions of the cover unit are inserted to stably couple the main unit with the cover unit when the cover unit closes; and lower cover fixing grooves concavely formed toward the opposite side of USB plug at both ends of the slide rail in the main unit so that the inserting protrusions of the cover unit are inserted to stably couple the main unit with the cover unit when the cover unit is inserted into the main unit in the opposite direction of the USB plug, and wherein the cover unit further comprises: inserting protrusions provided at both inner sides of the cover unit to be inserted into the upper cover fixing grooves and the lower cover fixing grooves to stably couple the cover unit with the main unit.

In the USB storage device according to the present invention, the inserting protrusions may be provided at both sides of the main unit, and the upper and lower cover fixing grooves corresponding to the inserting protrusions may be provided at both ends of both inner sides of the cover unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a USB storage device having a USB plug with top and bottom terminals according to an embodiment of the present invention;

FIGS. 2A and 2B are a perspective view and a plan view, respectively, of a main unit of a USB storage device having a USB plug with top and bottom terminals according to an embodiment of the present invention;

FIG. 3 is a plan view of a cover unit in a USB storage device according to an embodiment of the present invention;

FIG. 4 is a schematic diagram of a connection unit in a USB plug with top and bottom terminals according to an embodiment of the present invention;

FIG. 5 is a photograph for a USB port into which a USB plug with top and bottom terminals can be inserted according to an embodiment of the present invention; and

FIGS. 6A to 6D are perspective views illustrating a method of handling a cover unit in a USB storage device having a USB plug with top and bottom terminals according to an embodiment of the present invention.

### DETAILED DESCRIPTION OF THE INVENTION

A USB storage device having a USB plug with top and bottom terminals according to the present invention will now be described in detail.

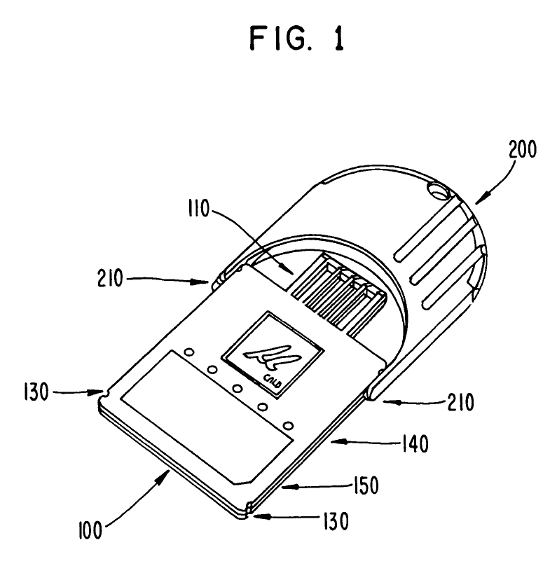

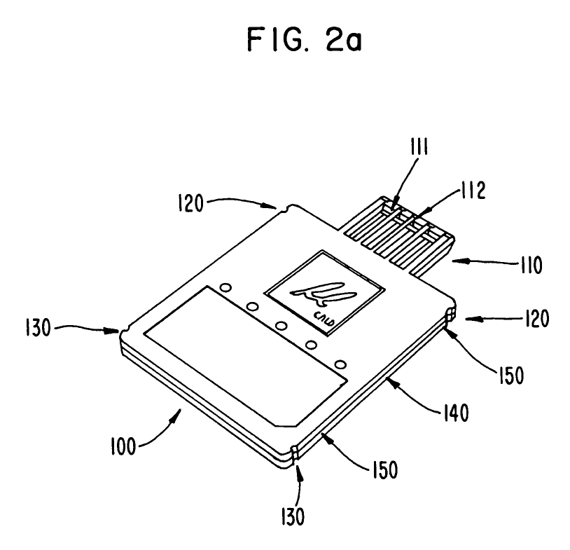

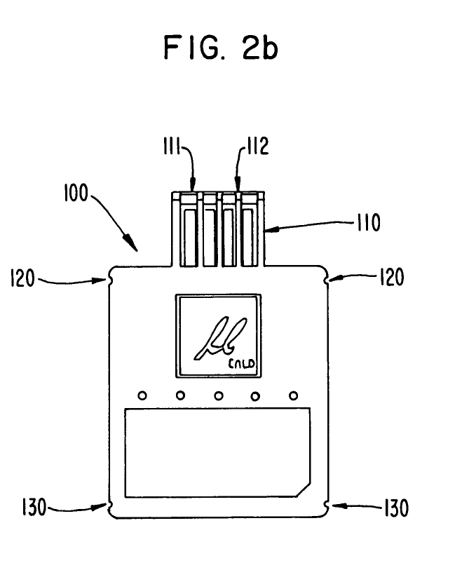

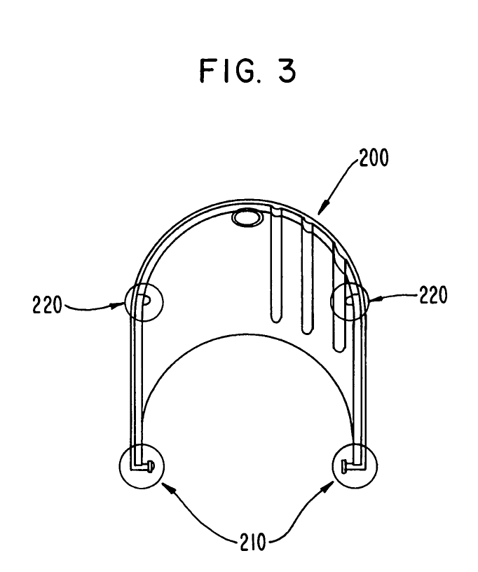

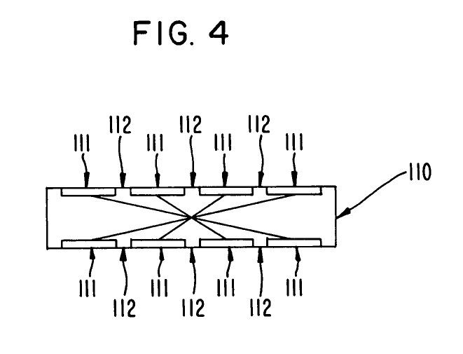

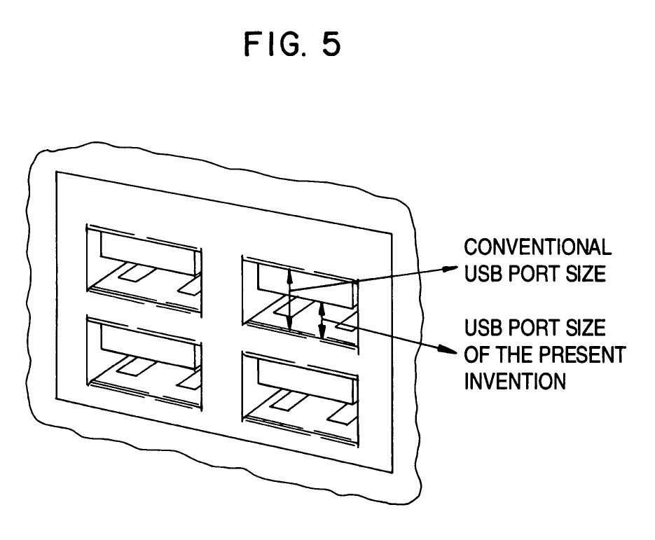

FIG. 1 is a perspective view of a USB storage device having a USB plug with top and bottom terminals according to an embodiment of the present invention; FIGS. 2A and 2B are a perspective view and a plan view, respectively, of a main unit of a USB storage device having a USB plug with top and bottom terminals according to an embodiment of the present invention; FIG. 3 is a plan view of a cover unit in a USB storage device according to an embodiment of the present invention; FIG. 4 is a schematic diagram of a connection unit in a USB plug with top and bottom terminals according to an embodiment of the present invention; and FIG. 5 is a photograph for a USB port into which a USB plug with top and bottom terminals can be inserted according to an embodiment of the present invention.

As shown in FIGS. 1 to 3, the USB storage device according to the present invention includes a main unit 100 and a cover unit 200. The main unit 100 includes a USB plug 110, upper cover fixing grooves 120, lower cover fixing grooves 130, slide rails 140 and slide rail projections 150, and the cover unit 200 includes rail protrusions 210 and inserting protrusions 220.

The main unit 100 comprises a memory device, which has an essential function of the USB storage device, and provides an overall appearance of the USB storage device. The memory device may include an IEEE 1394 device, a memory stick (MS), a compact flash card (CFC), a multi-media card (MMC), and a smart media card (SMC), based on the external format. The memory device is electrically arranged on a circuit board, together with electronic parts for electrical signal processing, and constitutes the main unit 100, the detail of which is omitted because it is apparent to the skilled in the art.

The USB plug will be connected to a USB socket of the information terminal apparatus such as a PC, a notebook, an MP3 player, and a digital camera, as shown in FIG. 4, comprising connection terminals 111 to communicate data. The connection terminals comprise a power supply terminal Vcc and a ground terminal GND to supply the information terminal apparatus with electrical power, and also comprise two terminals USB V+ and USB V− for data communication.

The connection terminals 111 are symmetrically connected at top and bottom sides with reference to a center of the USB plug 110, so that the connection terminals 111 of the USB plug 110 can be inserted into the information terminal apparatus in a face-down or face-up manner. Preferably, the USB plug 110 further includes a guide 112 made of dielectric material between the connection terminals 111 to prevent a short circuit between the connection terminals 111.

Further, the USB storage device according to the present invention makes the USB plug 110 thinner, so that the USB storage device is inserted into and connected to the thinner USB port than the conventional one, as shown in FIG. 5.

Therefore, other functional ports of the information terminal apparatus are neither blocked nor covered, thereby allowing other peripherals to be used simultaneously.

In particular, the thickness of the main unit 100 in the USB storage device is, preferably, 2 mm to 3 mm, and more preferably, 2.5 mm so that a variety of information terminal apparatuses such as digital cameras, digital camcorders, MP3 players, and PDAs that are limited by the size of the equipped USB port may be inserted.

The inserting protrusions 220 of the cover unit 200 are inserted into the upper cover fixing grooves 120, so that the cover unit 200 is stably coupled with the main unit 100 when the cover unit 200 is closed. Thus, when a user connects the USB storage device with a necklace or a band, the cover unit 200 is stably coupled with the main unit 100, thus not being easily separated

The inserting protrusions 220 of the cover unit 200 are inserted into the lower cover fixing grooves 130, so that the cover unit 200 is stably coupled with the main unit 100 when the cover unit is inserted into the lower part of the main unit 100 to use the USB storage device. Thus, when a user connects the USB storage device with the information terminal apparatus, the cover unit 200 is stably coupled with the main unit 100, thus not being easily separated.

Preferably, the upper cover fixing grooves 120 and the lower cover fixing grooves 130 are provided at both sides, however, they may be provided in the cover unit 200. In this case, the corresponding inserting protrusions 220 are provided in the main unit 100.

The slide rails 140 extend in the longitudinal direction at both sides of the main unit 100 of the USB storage device, and the slide rail projections 150 are provided at both ends of the slide rails 140 to prevent the cover unit 200 from being separated. A sliding range for the rail protrusions 210 of the cover unit 200 is confined into the entire length of the slide rails 140, so that the cover unit 200 can be prevented from being separated from the main unit 100.

Preferably, the slide rails 140 extend at both sides of the main unit 100, but it may be provided in the cover unit 200. In this case, the corresponding rail protrusions 21 are provided in the main unit 100.

The cover unit 200 serves to protect the USB plug 110 of the main unit 100 from external environment, and when rotating the cover unit 200, the cover unit 200 is preferably formed with a suitable size concavely toward the main unit 100, not to contact with the USB plug 110 or edges of the main unit 100.

The rail protrusions 210, which are inserted into the slide rails 140 of the main unit 100, are provided so that the cover unit 200 can rotatably move along with the rail.

The inserting protrusions 220, which are inserted into the upper cover fixing grooves 120 and the lower cover fixing grooves 130 of the main unit 100, are inserted into the upper cover fixing grooves 120 to prevent the cover unit 200 from being separated when a user closes the cover unit 200 to carry the USB storage device, and are inserted into the lower cover fixing grooves 120 to prevent the cover unit from being separated when a user inserts the cover unit 200 into the lower part of the main unit 100 to use the USB storage device.

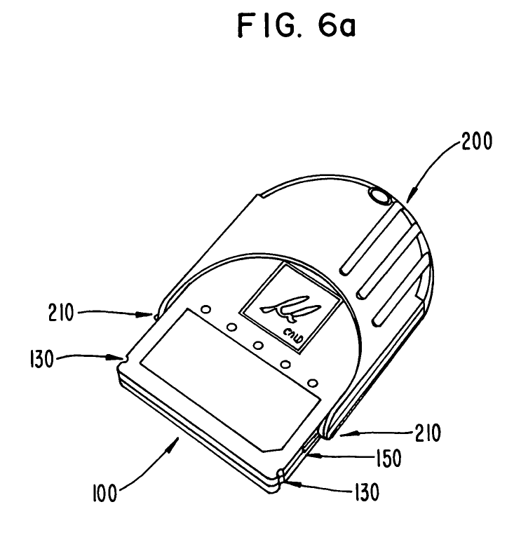

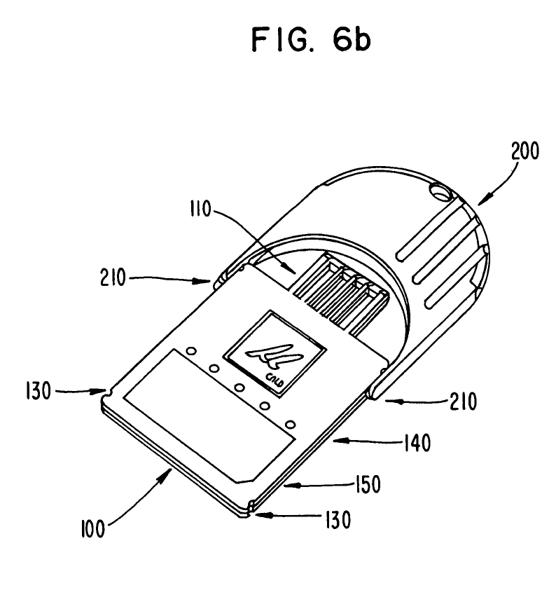

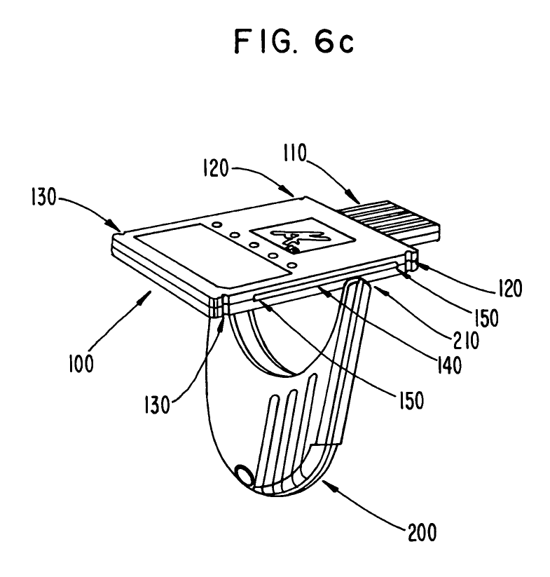

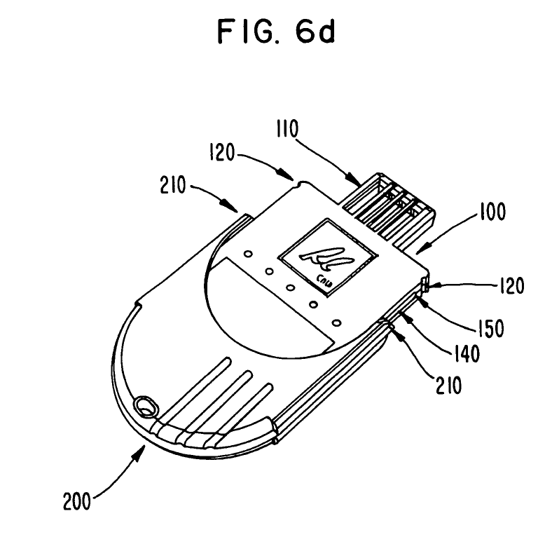

A method of handling a cover unit of a USB storage device having a USB plug with top and bottom terminals according to an embodiment of the present invention will be described with reference to FIGS. 6A to 6D

When a user closes the cover unit 200, the inserting protrusions 220 of the cover unit 200 are inserted into the upper cover fixing grooves 120 and the rail protrusions 210 of the cover unit 200 are inserted into the slide rails 140 to stably couple the main unit 100 with the cover unit 200, as shown in FIG. 6A. Therefore, when the USB storage device is detached from the information terminal apparatus for movement or custody, the cover unit 200 is prevented from being separated from the main unit 100.

When the user moves the cover unit 200 along with the main unit 100 to use the USB storage device, the inserting protrusions 220 of the cover unit 200 are left from the upper cover fixing grooves 120 and the rail protrusions 210 of the cover unit 200 move along the slide rail 140 of the main unit 100, as shown in FIG. 6B. Here, since there are slide rail projections 150 at both sides of the slide rails 150, when the inserting protrusions 220 contact with the slide rail projections 150, the user cannot move the inserting protrusions 220 any further, so that the cover unit 200 is prevented from being separated from the main unit 100.

When the user rotates the cover unit 200 to use the USB storage device, the cover unit 200 is rotated with a rotational axis of the rail protrusions 210 inserted into the slide rails 140 of the main unit 100, as shown in FIG. 6C. The side facing the main unit of the cover unit is formed concavely so that the cover unit 200 does not contact with the USB plug 110 or the edge of the main unit 100, when the cover unit 200 is rotated.

In rotating the cover unit 200, the user moves the rail protrusions 210 of the cover unit 200 down to the lower portion of the main unit 100 along with the slide rails 140 to insert the cover unit 200 into the lower part of the main unit 100. Here, since there are the slide rail projections 150 provided at both ends of the slide rails 140, when the inserting protrusions 220 contact with the slide rail projections 150, the user cannot move the inserting protrusions 220 any further, so that the cover unit 200 is prevented from being separated from the main unit 100.

When the user inserts the cover unit 200 into the lower part of the main unit 100 to use the USB storage device, the inserting protrusions 220 of the cover unit 200 are inserted into the lower cover fixing grooves 130 of the main unit 100 and the rail protrusions 210 of the cover unit 200 are inserted into the slide rails 140 of the main unit 100 to stably couple the main unit 100 with the cover unit 200, as shown in FIG. 6D. Therefore, when the user connects the USB storage device to the information terminal apparatus, the cover unit 200 is prevented from being separated.

After the user uses the USB storage device, operation for separating the USB storage device from the information terminal apparatus to close the cover unit 200 is a reverse process of operation by the time the cover unit 200 is inserted into the main unit to use the USB storage device, thus its detail description will be skipped herein.

As described above, the USB storage device of the present invention is equipped with the connection terminals of the USB plug at both top and bottom sides, so that it can be inserted into the information terminal apparatus such as a PC, a notebook, an MP3 player, a digital camera, in face-down/face-up manners.

Further, the USB storage device of the present invention confines a sliding range of the rail protrusions provided in the cover unit, to the slide rails provided in the main unit, thus preventing the cover unit from being separated and missing.

Further, in the USB storage device of the present invention, the inserting protrusions provided in the cover unit are inserted into the upper cover fixing grooves and the lower cover fixing grooves provided on the main unit, so that the cover unit is stably coupled with the main unit while in carrying or using the USB storage device.

Further, the USB storage device of the present invention can be provided as thick as the USB port, so that even when it is inserted into the information terminal apparatus, there is no effect on the peripheral devices, thus allowing various peripherals to be simultaneously used.

While the present invention has been described with reference to exemplary embodiments thereof, it will be apparent to those skilled in the art that various modifications and changes maybe made without departing from the scope of the present invention as defined by the following claims.

1. A USB storage device having a USB plug with top and bottom terminals comprising:
a main unit for receiving a memory device storing data; and
a cover unit protecting the main unit from external environment,
wherein the main unit comprises:
a USB plug having a connection terminal at one side thereof to be connected to a USB port of an information terminal apparatus to communicate data and another connection terminal at the other side thereof to be connected to the USB port of the information terminal apparatus to communicate data at the other side; and
slide rails provided in a longitudinal direction along both sides to define a sliding range for rail protrusions of the cover unit, and
wherein the cover unit comprises rail protrusions provided at both ends toward the main unit thereof to be inserted into the slide rails, so that the cover unit can rotatably move along with the slide rail.

2. The USB storage device according to claim 1,
wherein the slide rails extend in the longitudinal direction within the cover unit, and
wherein the rail protrusions corresponding to the slide rails are provided at both sides of the main unit.

3. The USB storage device according to claim 1, wherein the connection terminal at one side and the connection terminal at the other side of the USB plug are symmetrically coupled with reference to a center of the USB plug.

4. The USB storage device according to claim 1, wherein the USB plug further comprises a guide made of dielectric material between the connection terminals to prevent a short circuit between the connection terminals.

5. The USB storage device according to claim 1, wherein a thickness of the main unit is in a range of 2 mm to 3 mm so that the main unit can be inserted into a small-sized information terminal apparatus.

6. The USB storage device according to claim 1, wherein slide rail projections are provided at both ends of the slide rails to prevent the rail protrusions from being separated from the slide rails.

7. The USB storage device according to claim 1,
wherein the main unit further comprises:
upper cover fixing grooves concavely provided toward the USB plug at both ends of the slide rail in the main unit so that inserting protrusions of the cover unit are inserted to stably couple the main unit with the cover unit when the cover unit closes; and
lower cover fixing grooves concavely formed toward the opposite side of USB plug at both ends of the slide rail in the main unit so that the inserting protrusions of the cover unit are inserted to stably couple the main unit with the cover unit when the cover unit is inserted into the main unit in the opposite direction of the USB plug, and
wherein the cover unit further comprises:
inserting protrusions provided at both inner sides of the cover unit to be inserted into the upper cover fixing grooves and the lower cover fixing grooves to stably couple the cover unit with the main unit.

8. The USB storage device according to claim 7,
wherein the inserting protrusions are provided at both sides of the main unit, and
wherein the upper and lower cover fixing grooves corresponding to the inserting protrusions are provided at both ends of both inner sides of the cover unit.
